(19) United States
(12) Patent Application Publication
(10) Pub. No.: US 2006/0085295 A1
(43) Pub. Date: Apr. 20, 2006

(54) Inventory mapping system and method

(76) Inventors: David E. Droste, Rochester Hills, MI (US); Daniel T. Sheffield, Rochester Hills, MI (US); Thomas J. Sullivan, Trumbull, CT (US); Craig D. Carrick, Clarkston, MI (US); Linda Gamage, Rochester, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/954,139

(22) Filed: Sep. 29, 2004

(51) Int. Cl. A01K 5/02

(52) U.S. Cl. 705/28

(57) ABSTRACT

The present specification relates to inventory management. More specifically, the system and method disclosed in the specification provide for mapping inventories. In one of many possible embodiments, an inventory mapping method involves assigning fixture codes to inventory fixtures. The fixture codes are indicative of positional relationships of the inventory fixtures to each other. Fixture attributes associated with the inventory fixtures are gathered. The fixture attributes include the fixture codes. Output is generated from the fixture attributes. The output is indicative of the positional relationships of the inventory fixtures to each other.

### TECHNICAL FIELD

The present specification relates to inventory management. More specifically, the present system and method provide for mapping inventories.

### BACKGROUND

People and organizations (collectively “organizations”) involved with the sale of goods often design the layouts of stores (e.g. retail grocery stores) so as to locate and accommodate inventory in a manner that will promote sales, meet customer needs, and make shopping experiences convenient. A blueprint may be created for a store to specify where specific goods or categories of goods should be located. The blueprint may also indicate how much space should be provided for goods or for specific categories of goods.

The store layouts are often designed based on the results of market research (e.g., surveys) designed to identify the preferences and needs of consumers. Because market research often indicates different customer preferences and needs based on geographic, cultural, or other influences, an optimal inventory layout will not be the same for every store. Thus, a large organization with multiple stores in different geographic locations may choose to utilize different inventory layouts for its stores. Other organizations may choose to utilize a particular inventory layout for a group of stores in order to provide customers with a familiar layout at the different stores within the group. In any event, with optimal inventory layouts in place, sales are generally increased, and customers usually have predictably convenient shopping experiences.

However, once an optimal inventory layout has been designed and implemented for a particular store, numerous factors exist that contribute to undesirable departures away from the optimal inventory layout. For example, people who stock inventory in the store may inadvertently introduce migrations and fluctuations into the actual layout of inventory in the store. Some inventory stockers may even intentionally cause departures from the optimal layout for various reasons, such as to fit an entire box of goods on a shelf. Further, third parties often lobby for increased exposure of their products in stores. In a situation where a product distributor stocks the shelves with the distributor's products, the distributor may adjust the actual layout of inventory in order to obtain premium or increased shelf space for the distributor's products, a practice commonly referred to as “shelf wars.” Still further, geographic influences may lead local store managers to choose to depart from optimum layouts based on their own judgment.

A significant problem associated with departures away from optimal inventory layouts is that organizations are largely unaware of the departures. This problem is of particular concern to large organizations that have multiple stores spread over different geographic areas. Traditionally, there is no efficient and accurate way for organizations to track and verify the actual inventory layouts being used in stores. Thus, organizations cannot take action to correct harmful departures from the optimal inventory layouts because the organizations do not have accurate and up-to-date information concerning the actual inventory layouts of stores. The result is often unnoticed continued use of less-than-optimal inventory layouts, which can result in decreased sales, lack of consistency between an organization's stores, lack of customer satisfaction, violation of contractual obligations with suppliers or distributors of goods, and damaged reputation.

### SUMMARY

The present method and system provide for mapping inventories. In one of many possible embodiments, an inventory mapping method involves assigning fixture codes to inventory fixtures. The fixture codes are indicative of positional relationships of the inventory fixtures to each other. Fixture attributes associated with the inventory fixtures are gathered. The fixture attributes include the fixture codes. Output is generated from the fixture attributes. The output is indicative of the positional relationships of the inventory fixtures to each other.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1 is a block diagram of an example of a system for mapping inventory according to one embodiment.

FIG. 2 is a front-view of an example of a fixture tag having spaces provided for placement of an ASC number according to one embodiment.

FIG. 3 is a floor-plan view of an example of a retail grocery store that can be mapped with the system of FIG. 1.

FIG. 4 is an enlarged floor-plan view with aisle labels assigned to particular fixtures of FIG. 3.

FIG. 5 is another enlarged floor-plan view with side labels assigned to particular fixtures of FIG. 3.

FIG. 6 is another enlarged floor-plan view with section labels assigned to particular fixtures of FIG. 3.

FIG. 7A is another enlarged floor-plan view with ASC numbers assigned to particular fixtures of FIG. 3.

FIG. 7B is a floor-plan view of the retail grocery store of FIG. 3 with ASC numbers assigned to fixtures.

FIG. 8 is a flowchart diagram of an exemplary method for using inventory mapping to perform an inventory audit of the retail grocery store of FIG. 3.

Throughout the drawings, identical reference numbers designate similar, but not necessarily identical, elements.

### DETAILED DESCRIPTION

The system and method disclosed in the present specification provide for mapping inventories. Inventories are mapped using unique identifiers to identify fixtures that hold goods. The unique identifiers are assigned to fixtures based on location and relationship to other fixtures in an inventory target area. The system and method are configured to use the unique identifiers to generate output indicative of positional relationships between the fixtures and/or positions of products in relation to the fixtures and/or other products. In other words, the output is representative of actual inventory layouts. The unique identifiers may also be used to assist in the population of mapping databases and to check for errors and omissions in inventory mapping processes.

I. System Overview

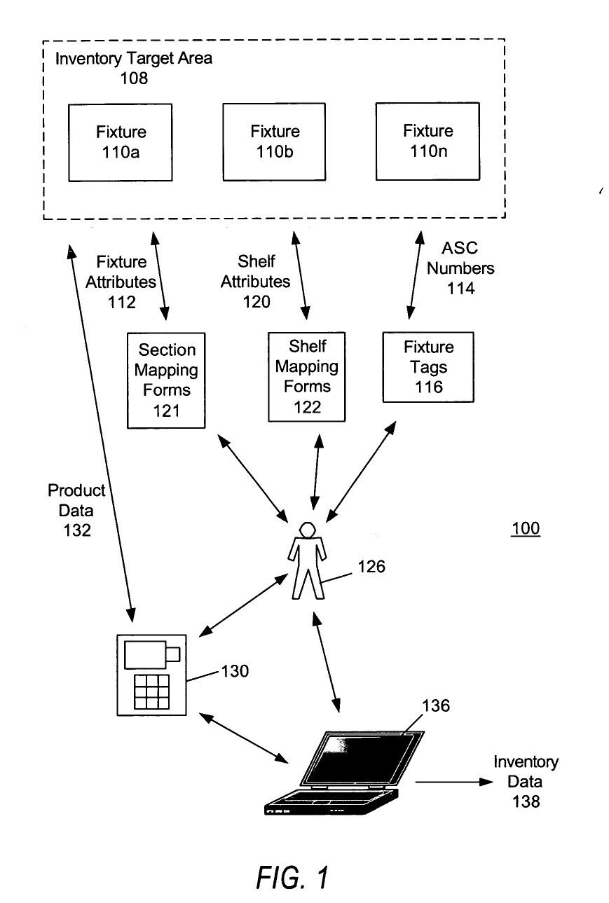

FIG. 1 is a block diagram of an example of a system 100 for mapping inventory according to one embodiment. As shown in FIG. 1, the system 100 provides for mapping an inventory target area 108 having a number of fixtures 110a, 110b, . . . 110n (collectively “fixtures 110”).

A. Inventory Target Area

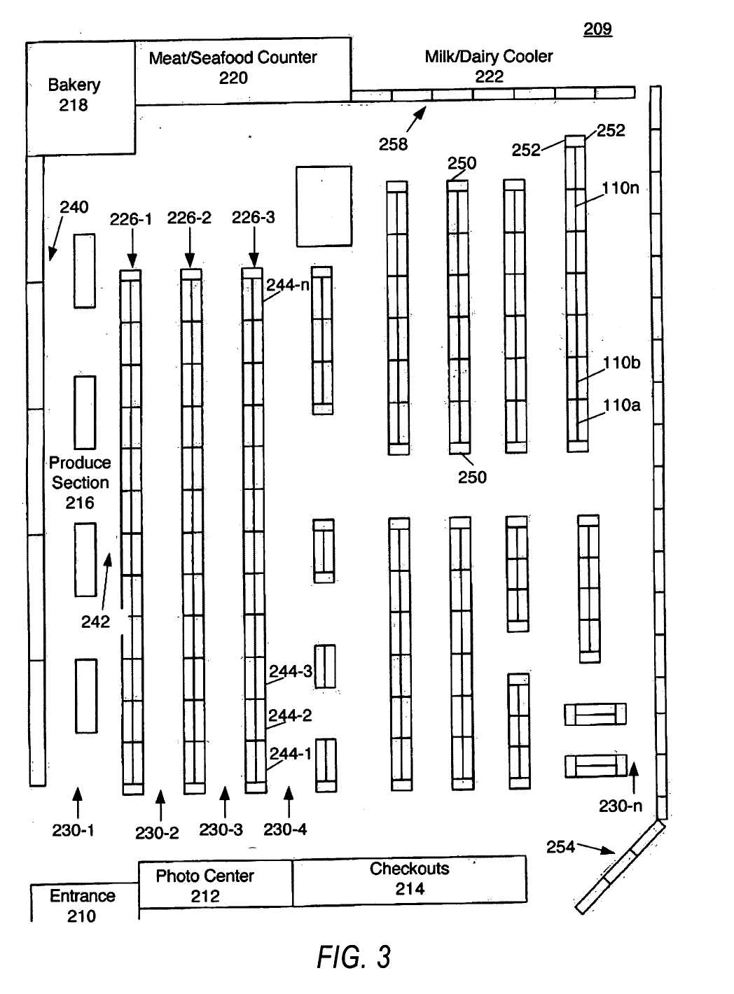

The target area 108 can be any location or premises for holding inventory, including but not limited to a retail establishment, a distributor location, a warehouse, a manufacturing location, a shipping unit, and the like. FIG. 3, which will be discussed below, is a floor-plan view of a retail grocery store that can be mapped using the system 100 of FIG. 1.

B. Fixtures

Returning now to FIG. 1, fixtures 110 in the inventory target area 108 can include any apparatus for holding inventory, including but not limited to display furnishings, shelving units, gondolas, tables, pegboards, walls (e.g., slatted walls), shipping containers, plats, and the like. The fixtures 110 can be various sizes, types, and designs. Fixtures 110 define sections of display runs. Thus, for purposes of mapping inventory based on locations of fixtures 110 or sections, the term “sections” can be used synonymously with fixtures 110.

C. Fixture Attributes

The fixtures 110 have fixture attributes 112 describing characteristics of the fixtures 110. Fixture attributes 112 can describe any characteristics of fixtures 110, including but not limited to fixture numbers, fixture types, fixture widths, fixture heights, and fixture numbers identifying adjacent fixtures 110. The fixture numbers can include ASC numbers 114. Thus, fixture attributes 112 for a particular fixture 110 may include a fixture code (e.g., an ASC number 114) identifying the particular fixture 110, a different ASC number 114 identifying another fixture 110 positioned to the left of the particular fixture 110 (“ASC left number”), another ASC number 114 identifying another fixture 110 positioned to the right of the particular fixture 110 (“ASC right number”), and yet another ASC number 114 identifying another fixture 110 positioned opposite the particular fixture 110. As will be discussed below in more detail, ASC numbers 114 are configured to identify a location of fixtures 110 in the inventory target area 108, as well as positional relationships between fixtures 110.

Fixture types can include gondolas, end caps, wings, freezers, coolers, perimeter service departments, center store service departments, and other types of fixtures 110 that may be located in the inventory target area 108. Fixture types may be limited to types within a predefined set. As will be discussed below, fixture types can be assigned numerical identifiers that the system 100 is configured to interpret.

Fixture attributes 112 may include fixture widths indicating the widths of the fixtures 110 measured from frame to frame. The system 100 can be configured to limit the widths of fixtures 110 to specific values for each fixture type. For example, gondola-type fixtures may come only in certain widths. Accordingly, the system 100 may be configured to allow only those predefined widths for gondola-type fixtures 110.

Similarly, fixture attributes 112 can include fixture heights indicating the heights of fixtures 110 measured from the top of the fixtures 110 to the floor. As discussed above in relation to fixture widths, the system 100 can be configured to limit the heights of fixtures 110 to specific values for each fixture type. For example, gondola-type fixtures may exist only in certain heights. Accordingly, the system 100 may be configured to allow only those predefined heights for gondola-type fixtures 110.

D. ASC Numbers

As mentioned above, fixture attributes 112 can include aisle-section-category (ASC) numbers 114. ASC numbers 114 are configured to identify locations of fixtures 110, as well as positional relationships between fixtures 110, which will be discussed below in more detail. In one embodiment, ASC numbers 114 comprise five-digit numerical codes, in which the first two digits represent an aisle-label, the third digit represents a side-label indicative of a side of an aisle, and the last two digits represent a section-label. Values for aisle, side, and section labels can be assigned to fixtures 110 based on mapping techniques discussed below so that the labels that make up the ASC numbers 114 tend to indicate positions of fixtures 110. ASC numbers 114 will be better understood below where they are described in relation to FIGS. 3-7B.

E. Fixture Tags

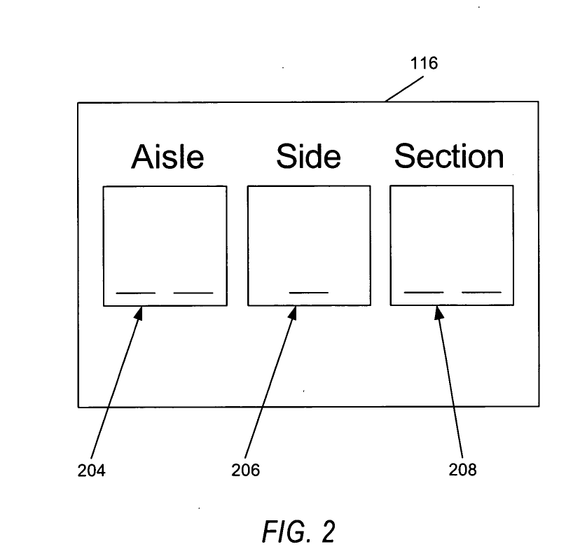

The system 100 can include fixture tags 116 (also referred to as “audit tickets”) for identifying fixtures 110 in the inventory target area 108. The fixture tags 116 can include any instrument that can be attached to the fixtures 110. For example, the fixture tags 116 may comprise preprinted identification tags or other identifiers having space available for placement of a number or other symbol identifying a particular fixture 110. These numbers or symbols may include aisle-section-category (ASC) numbers 114. FIG. 2 is a front-view of an example of a fixture tag 116 having spaces provided for placement of an ASC number 114 having an aisle label 204, a side label 206, and a section label 208. The fixture tag 116 can be attached to fixtures 110 in myriad ways, including taping it to any particular fixture 116. An exemplary ASC numbering technique useful for labeling fixtures 110 with ASC numbers 114 will be discussed in detail below.

F. Shelf Attributes

Fixtures 110 may or may not include shelves. For those fixtures 110 having shelves, the shelves include shelf attributes 120. Shelf attributes 120 can include any characteristic of the shelves or the shelves' housing fixtures 110, including but not limited to ASC numbers 114, shelf numbers, shelf tags, shelf heights, and shelf depths.

Shelf numbers can be systematically assigned. For example, the top-most shelf of a particular fixture 110 is assigned to be shelf number “1.” Shelf numbers then increment moving downward from the top shelf to the next shelf. If a particular fixture 110 does not include a shelf, the shelf number can be assigned to a specific value (e.g., “90”) that the system 100 is configured to recognize as an indication that the fixture 110 does not have a shelf.

Shelf height is the distance from one shelf to an adjacent shelf. For the top-most shelf, the shelf height can be defined as the distance from the top shelf to the top of the fixture 110 or the height of the tallest product on the shelf. Shelf height can be determined by measurement or observation. In one embodiment, the system 100 is configured to compare the height of a particular fixture 110 with the sum of the shelf heights for the fixture 110 to detect an error in determining fixture attributes 112 or shelf attributes 120. For example, if the sum of shelf heights is greater than the fixture height for a particular fixture 110, the system 100 can indicate this condition to alert a user of the system 100 of a possible error.

Shelf depth is the distance from the very back of a shelf to the lip of the front of the same shelf. This distance can be determined by measurement or observation.

Shelf tags include tags located on shelves. Shelf tags may provide information tending to identify categories of products on the shelves. Shelf tags can include bar codes capable of being scanned to identify the category of products. If a shelf does not have a shelf tag, the shelf can be assigned a shelf tag value that the system 100 is configured to recognize as indicating a lack of a shelf tag.

G. Forms

The system 100 can include forms for use in the gathering and recording of mapping data. As shown in FIG. 1, fixture attributes 112 may be gathered and recorded using section-mapping forms 121, while shelf attributes 120 may be gathered and recorded using shelf-mapping forms 122.

Section-mapping forms 121 can be used to record fixture attributes 112. The section-mapping forms 121 may provide fields for entry of fixture attributes 112, including fixture types, fixture widths, fixture heights, ASC numbers 114 for fixtures 110, and ASC numbers 114 for adjacent fixtures 110.

Similarly, shelf-mapping forms 122 can be used to record fixture attributes 112 and shelf attributes 120. The shelf-mapping forms 122 may provide fields for entry of the fixture attributes 112 and/or the shelf attributes 120, including ASC numbers 114 for a particular fixture 110, shelf numbers, shelf heights, shelf lengths, and shelf depths.

The forms 121, 122 can be paper forms or some other medium capable of recording data. In some embodiments for example, the forms 121, 122 may be electronic interfaces (e.g., graphical user interfaces (GUI)) running on a portable computing device.

H. Auditor

As shown in FIG. 1, an auditor 126 can use the fixture tags 116, the section-mapping forms 121, and the shelf-mapping forms 122 to map fixtures 110 in the inventory target area 108. The forms 121, 122 and the fixture tags 116 are provided for the auditor 126 to use to identify fixtures 110 and to gather and record fixture attributes 112 and shelf attributes 120.

The auditor 126 can comprise any number of personnel that operate or utilize the system 100 to map the inventory target area 108 and/or gather and process inventory product data. While FIG. 1 shows a single FIGURE to represent the auditor 126, the auditor 126 is intended to include any number of personnel ranging from one auditor 126 to a team of auditors 126.

I. Audit Device

An audit device 130 may be provided for gathering product data 132. Auditor 126 can manually enter product data 132 into the audit device 130 using a keypad or other input device. For example, in a mapping process, auditor 126 can key data such as ASC numbers 114, fixture attributes 112, and shelf attributes 120 into the audit device 130. The auditor 126 can then use the audit device 130 to scan product data 132 and shelf tags. The audit device 130 should include a scanner capable of scanning bar codes and other information related to products.

Using the audit device 130, the auditor 126 may enter an ASC number 114 and shelf number to identify a particular shelf of a fixture 110. The auditor 126 can then scan shelf tags that are on the shelf. If there is not a bar code on the shelf tag, the shelf tag number can be keyed into the audit device 130. In the event that the shelf tag is invalid, the audit device 130 allows the auditor 126 to override the scan. In the event that there is not a shelf tag on the shelf, a predetermined value (e.g., “0”) can be entered, which value can be recognized by the system 100 to indicate a lack of shelf tags on a shelf.

The auditor 126 can then systematically (e.g., left to right) scan bar codes on each product at the forefront of the shelf (referred to as “facing” products) to obtain product data 132 and to determine how many of those particular products can fit across the front row of products on the particular shelf for space management analysis. In the event that there are not enough products to fill the length of the shelf, present products can be scanned as many times as auditor 126 estimates will fit across the shelf. In the event that no product is present on the shelf (i.e., out of stock), a predetermined value (e.g., “888”) can be entered, and the system 100 is configured to recognize this to indicate that products are out of stock. In the event that a product bar code is invalid, the audit device 130 can provide the auditor 126 with capabilities to override any invalid bar code.

The audit device 130 includes programming logic (e.g., software programs) configured to facilitate entry and recording of product data 132 in the audit device 130. In particular, the programming logic provides steps, modules, and/or fields for the entry of product data 132, fixture attributes 112, and shelf attributes 120.

J. Product Data

The product data 132 can include any information related to the inventory goods and/or their location. For example, the product data 132 may include ASC numbers 114, shelf numbers, bar codes (e.g., product universal product codes (UPC)), product label information, shelf tag information, and the like.

K. Computer

As shown in FIG. 1, the system 100 can include a computer 136 that can be operated by auditors 126. Auditors 126 are able to enter the gathered product data 132, fixture attributes 116, shelf attributes 122, and ASC numbers 114 (collectively mapping data 138) into the computer 136. Product data 132 may then be uploaded from the audit device 130 by any electronic transfer method and medium known to those skilled in the art. The auditor 126 can also manually enter data into the computer 136 (e.g., key into the computer 136).

The computer 136 can include any device or combination of devices that allows the processing of the system 100 to be performed. The computer 136 may be a general purpose computer capable of running a wide variety of different software applications or a specialized device limited to particular functions. In some embodiments, the computer 136 is a portable computer. In other embodiments, the computer 136 is a network of computing devices. The computer 136 may include any type, number, form, or configuration of processors, system memory, databases, computer-readable mediums, peripheral devices, and operating systems. The term software applications is meant to be understood broadly and can include firmware, middleware, microcode, embedded logic, and any other type of instructions that can be processed by the computer 136.

The computer 136 can be configured for receiving, processing, recording, testing, formatting, and transmitting the mapping data 138. The computer 136 can organize inputted mapping data 138 into databases. Further, the computer 136 includes programming logic (e.g., software applications/programs) configured to instruct processors of the computer 136 to perform steps for testing for accuracy and completeness of the received mapping data 138. The computer 136 is able to analyze and compare ASC numbers 114 to test for accuracy and completeness of the received mapping data 138. Significantly, the computer 136 is configured to compare ASC numbers 114 to identify positional relationships between fixtures 110. From the positional relationships indicated by the ASC numbers 114, the computer 136 is configured to identify any discrepancies or omissions in the mapping of fixtures 110. For example, the computer 136 can be configured to recognize a condition in which a fixture attribute 112 (or shelf attribute 120) for a particular fixture 110 does not match up with product data 132. One example of an error that can be identified by the computer 136 is a fixture attribute 112 (e.g., a left ASC number 114) identifying another fixture 110 to the left of the particular fixture 110 but where no product data 132 has been entered for the fixture 110 to the left or where the ASC number 114 for the fixture 110 to the left does not match the left ASC number 114 in the fixture attributes 112 of the first fixture 110. The computer 136 can alert the auditor 126 of these conditions, thereby giving the auditor 126 opportunity to verify whether a lack of product data 132 is intentional or an accidental omission.

The computer 136 can be further configured to test whether ASC numbers 114 are properly assigned, input into the computer 136, and all accounted for. This can be performed by detecting any discrepancies in the positional relationships identified by ASC numbers 114 of adjacent fixtures 110.

The computer 136 can be further configured to check whether shelf data is properly assigned and input in the computer 136. The computer 136 may also be configured to determine whether the number of shelves in each fixture 110 is accurate and/or the shelf data sequence is correct. Missing or blended shelf attributes 120 or product data 132 can also be identified.

Instructions embodied on a computer-readable medium of the computer 136 can be configured to direct the computer 136 to perform any of the functions described herein, including testing for accuracy and completeness of inventory mapping data based on positional relationships indicated by ASC numbers 114 assigned to fixtures 110. By performing the functions described above, the computer 136 can reconcile and close out the mapping data. The computer 136 can generate section and shelf mapping reports for use by the auditor 126.

The computer 136 is configured to generate output (e.g., the mapping data 138) indicative of the positional relationships of the fixtures 110 with each other. The output can be generated based on fixture attributes 112, ASC numbers 114, shelf attribute 120, product data 132, and/or any other information associated with the fixtures 110 or the products. The output can also be indicative of product data and the positions of products and/or product categories in relation to the fixtures 110. The output may also indicate the positions of products and/or product categories to each other. For example, the output can indicate that the product category of “cold medicine” is located opposite of (i.e., across the aisle from) the product category of “hair care.” The output generated by the computer 136 can take various forms, including reports, tables, spreadsheets, data streams, and the like. Sometimes, the output generated by the computer 136 can be in the form of a graphical “map” of the store, showing the various fixtures and the product categories associated with them. Moreover, sometimes a data stream generated by the computer 136 can be used subsequently by another computer to automatically generate a graphical “map” of the store.

The computer 136 is able to format the generated output and send it on to another location, device, or entity for further processing. The output can be formatted into any of the forms listed above and can be referred to as mapping data 138 as shown in FIG. 1. Other locations, devices, or entities to which the mapping data 138 may be transmitted can include a regional audit location, a central audit location, and/or a customer. The transmission to another entity can be performed using any known method or connection for transmitting electronic data. Alternative or in addition to electronic data transfer, hardcopies of the mapping data 138 may be sent to the other entity.

Those skilled in the art will recognize that variations of the hardware of the system 100 of FIG. 1 can be implemented in the system 100 without departing from the spirit or scope of the present invention.

II. Exemplary Aisle-Section-Category Labeling Process

The system 100 implements a novel process of using ASC numbers 114 to map fixtures 110 in the inventory target area 108. The ASC numbering process assigns unique ASC numbers 114 to fixtures 110 in the inventory target area 108. The ASC numbers 114 identify fixtures 110 as well as positional relationships between adjacent fixtures 110. With the assigned ASC numbers 114, the system 100 can determine the positional relationships of fixtures 110 with one another, as well as the location of the fixtures 110 in the inventory target area 108. The ASC numbering process enables the system 100 to map the inventory target area 108 and to use the map to test for accuracy and completeness of mapping data 138, thereby reducing errors that occur in an inventory audit process. An exemplary ASC numbering process will now be described with reference to FIGS. 3-7B.

FIG. 3 is a floor-plan view of an example of a retail grocery store 209 that can be mapped according to one embodiment. As shown in FIG. 3, the retail grocery store 209 can include an entrance 210, a photo center 212, checkouts 214, a produce section 216, a bakery 218, a meat/seafood counter 220, and a milk/dairy cooler 222. The retail grocery store 209 further includes fixtures 110, some of which are arranged in runs 226-1, 226-2, 226-3, . . . 226-n (collectively “runs 226”) to form aisles 230-1, 230-2, 230-3, 230-4, . . . 230-n (collectively “aisles 230”). Aisles 230 are defined as the aisle space that customers can occupy within runs 226 or perimeter walls. Many aisles 230 have a “left side” and a “right side,” which are respectfully designated in FIG. 3 by reference numbers 240 and 242 for aisle 230-1. The left side of an aisle 230 can be referred to as side “A,” while the right side of the aisle can be referred to as side “B.” Further, the runs 226 include sections 244-1, 244-2, 244-3, . . . 244-n (collectively “sections 244”), which sections are usually defined by and coincide with individual fixtures 110.

Other types of fixtures 110 are arranged to form end caps 250 and wings 252 at the ends of runs 226. Other types of fixtures 110 are arranged to form a front display run 254 toward the front of the store 209 and a back display run 258 toward the back of the store 209. The store 209 also includes types of fixtures 209 that will not be mapped. For example, the photo center 212, checkouts 214, produce section 216, bakery 218, meat/seafood counter 220, and milk/dairy cooler 222 need not be mapped. However, these types of fixtures 110 should be assigned ASC numbers 114 to help define locations of and positional relationships with adjacent fixtures 110.

The retail grocery store 209 shown in FIG. 3 can be mapped according to the novel ASC mapping process. The ASC mapping process includes a number of predefined rules that direct the mapping of the store 209. The predefined rules define a method for assigning unique ASC numbers 114 to the fixtures 110 in the store 209. With a coded numerical map of fixtures 110 in the store 209, the system 100 can identify locations of fixtures 110, positional relationships between fixtures 110, and errors and/or omissions that may have been made in an inventory audit. The positional relationships between adjacent fixtures 110 can be utilized to check for errors in product data 132. Fixtures 110 can be assigned ASC numbers 114 according to the exemplary rules outlined below.

A. Aisle Labels

Fixtures 110 are identified by their respective aisle 230 and section 244 locations. Preferably, each fixture 110 in the store 209 is assigned an aisle label 204, a side label 206, and a section label 208. The aisle labels 204 can be inserted as the first two digits of the ASC numbers 114.

Aisles 230 in the store 209 should be assigned aisle labels 204 that are based on location in the store 209. In one embodiment, the left-most aisle 230-1 in the store 209 is assigned an aisle label 204 of “01.” Moving along the aisles 230 toward the right, the aisle label 204 for each aisle 230 increments. Thus, the aisle 230-2 to the right of aisle 230-1 is assigned the aisle label 204 of “02,” the aisle 230-3 to the right of aisle 230-2 is assigned the aisle label 204 of “03,” and so on until the right-most aisle 230 in the store is assigned an aisle label 204. From the aisle labels 204, the system 100 is able to determine the location of a particular aisle 230 in the store 209. In one embodiment, the aisle labels 204 for standard aisles 230 are Within a range from “01” up to and including “29.” Of course, this range can be modified for inventory target areas 108 in which more than thirty aisles 230 are to be mapped.

Certain types of fixtures 110 located around the perimeter of the store 209 may be assigned specific aisle labels 204 that the system 100 is configured to recognize as indicating a perimeter position. For example, in one embodiment, fixtures 110 making up the back display run 258 are assigned aisle labels 204 of “30,” and fixtures 110 making up the front display run 254 are assigned aisle labels 204 of “40.”

End caps 250 are another type of fixture 110 that should also be assigned aisle labels 204. In one embodiment, end caps 250 are assigned aisle labels 204 corresponding with the aisle 230 to the left of the end caps 250. For example, end caps 250 located in between aisle 230-3 and aisle 230-4 (i.e., on run 226-3) are assigned with aisle labels 204 (e.g., “03”) associated with aisle 230-3.

Wings 252 should also be assigned aisle labels 204. The aisle-labels 204 assigned to wings 252 can correspond with the aisle 230 that the wings 252 are facing. For example, an end cap 250 on run 226-3 may form two wings 252 at the end of the run. One of the wings 252 faces aisle 230-3 and will be assigned an aisle label of “03,” while the other wing faces aisle 230-4 and will be assigned an aisle label of “04.”

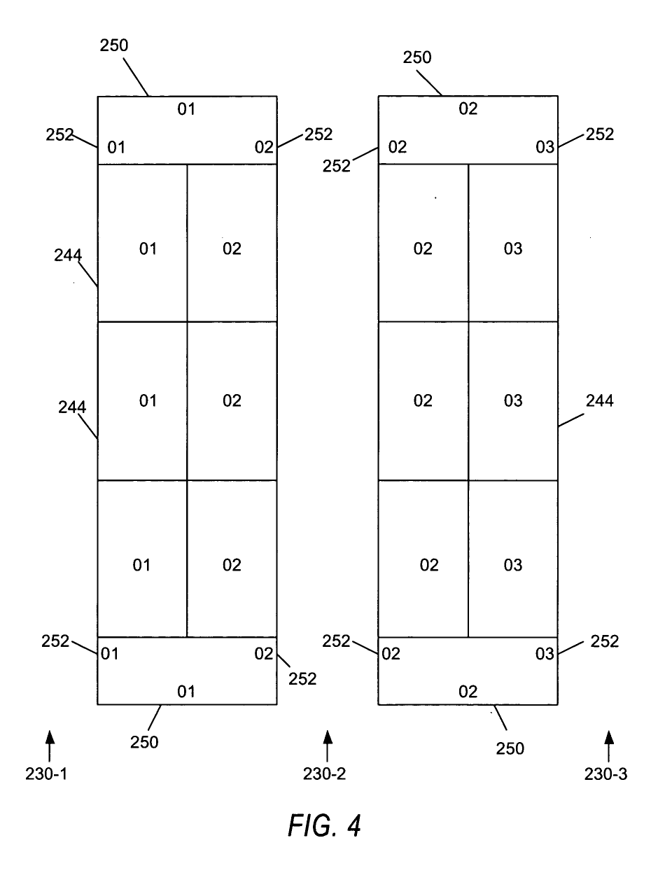

FIG. 4 is an enlarged floor-plan view of particular fixtures 110 of the store 209 of FIG. 3 with section labels 204 identified for each section defined by the fixtures 110. FIG. 4 shows shortened versions of the runs 226-1, 226-2 shown in FIG. 3. As shown in FIG. 4, sections 244, end caps 250, and wings 252 are assigned aisle labels 204 corresponding to the aisles 230-1 (“01”), 230-2 (“02”), and 230-3 (“03”).

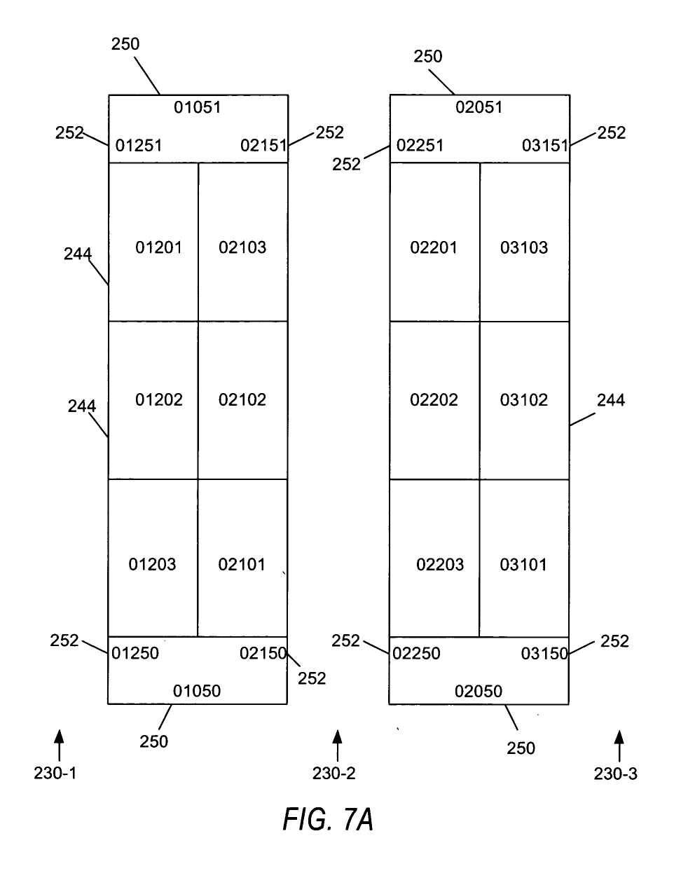

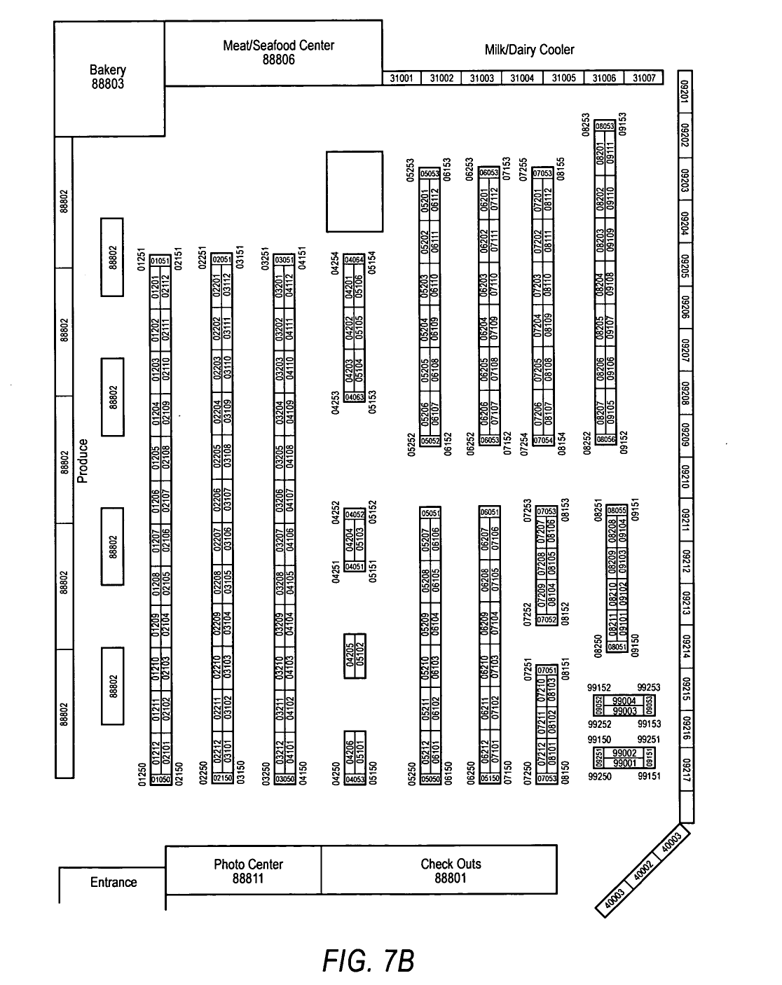

Other types of fixtures 110 of the store 209 that do not include inventory to be mapped may still be assigned ASC numbers 114 to help in the verification process discussed herein. These types of fixtures 110 can be assigned a predetermined aisle label 204 (e.g., “88”) that the system 100 is configured to interpret to mean no mapping data is mapped for those particular types of fixtures 110. For example, the checkouts 214 can be assigned an ASC number 114 of “88801” (aisle label 204 is “88”). FIG. 7B shows a number of fixtures 110 having aisle labels 204 of “88.”

B. Side Labels

With respect to the sides of aisles 230, side labels 206 can be assigned to indicate whether a particular section 244 defined by a fixture 110 is located on the left side or the right side of an aisle 230. In one embodiment, for sections 244 located on a left side 240 of an aisle 230, a side label 206 of “1” is used in the ASC numbers 114. On the other hand, a side label 206 of “2” is used in the ASC numbers 114 for sections 244 located on the right side 242 of an aisle 230. For fixtures 110 that are located where a “side” designation is not applicable, a side label 206 of “0” is used. Examples of fixtures 110 that will be assigned a “0” side-label include front display runs 254, back display runs 258, end caps 252, and types of fixtures 110 that will not be mapped for inventory. The side label 206 is inserted as the third digit of ASC numbers 114.

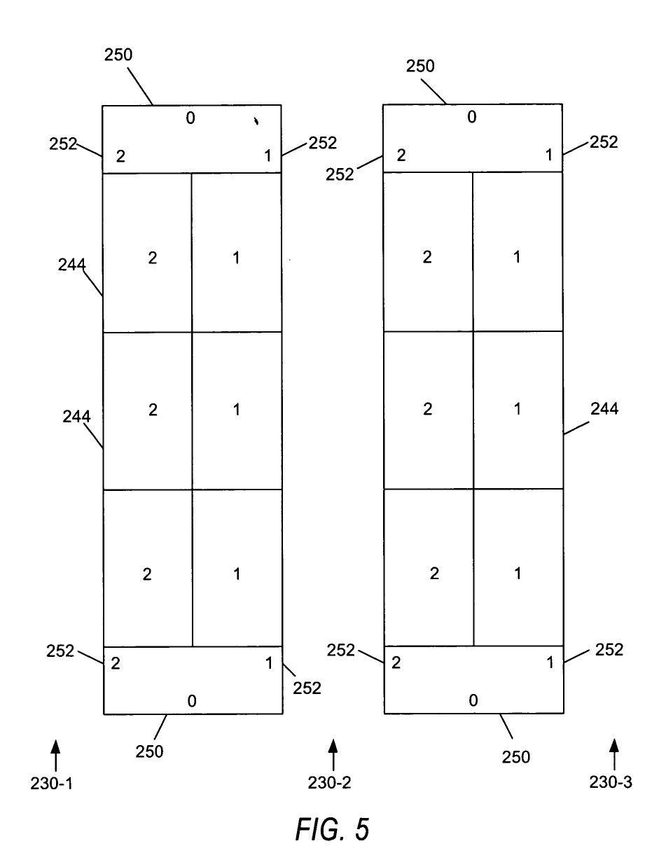

FIG. 5 is an enlarged floor-plan view of certain fixtures 110 in the store 209 shown in FIG. 3 with side labels 206 assigned to the fixtures 110. FIG. 5 shows shortened versions of the runs 226-1, 226-2 shown in FIG. 3. As shown in FIG. 5, sections 244 and wings 252 are assigned side labels 206 corresponding to their respective sides of the aisles (“01” for left side and “02” for right side). End caps 250 are assigned a side label 206 of “0.”

C. Section Labels

With respect to section labels 208 for fixtures 110, section labels 208 can be assigned to indicate where a particular fixture 110 is located along an aisle 230. A two-digit numerical code can be used for the section label 208. In one embodiment, the left-most section 244 defined by a fixture 110 on a particular side of an aisle 230 is assigned a section label 208 of “01,” and the section 244 immediately to the right of the left-most fixture 110 is assigned a section label 208 of “02.” For example, section 244-1 shown in FIG. 3 is assigned a section label 208 of “01,” section 244-2 is assigned a section label 208 of “02,” section 244-3 is assigned a section label 208 of “03,” and so on until the right-most section 244-n on the same side of aisle 230-4 is assigned a section label 208. The left-most section 244 on a particular side of the aisle 230 is defined to be to the left of an auditor 126 facing the sections 244.

Other types of fixtures 110 can be assigned with specific section labels 208 to enable the system 100 to identify the type of fixture 110. For example, end caps 250 can be assigned section labels 208 of “50” to indicate the end caps 250 that are closest to the front of the store 209 for a particular run 226. End caps 250 on the same run 226 can be assigned incrementing section labels 208 that increment as the end caps 250 move toward the back of the store 209. On a particular run 226 for example, the end cap 250 closest to the front of the store 209 is assigned a section label 208 of “50,” and the next end cap 250 on the run 226, moving from the front of the store 209 toward the back, is assigned a section label 208 of “51.” The section-label would continue to increment for additional end caps 250 on the same run 226.

Similar to end caps 250, wings 252 can also be assigned “50” series section labels 208 that increment for each wing 252 on a particular run 226. Wings 252 and end caps 250 are distinguishable by their side labels 208: wings 252 will have a non-zero side label 206, while end caps 250 are assigned a “0” side label 206.

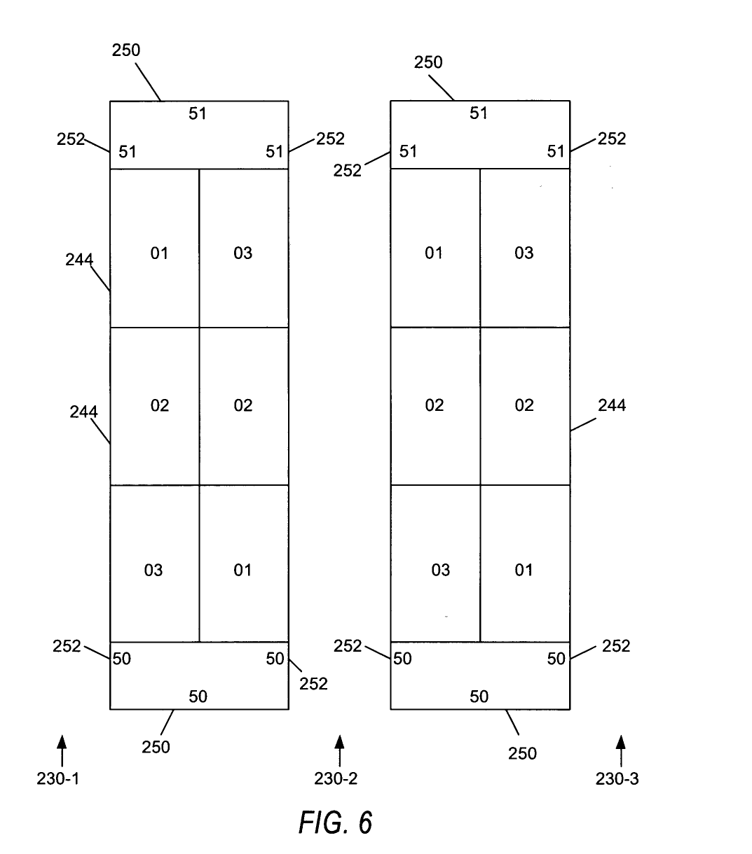

FIG. 6 is another enlarged floor-plan view of certain fixtures 110 of the store 209 shown in FIG. 3, with section labels 208 assigned to the fixtures 110. For sections 244 along the sides of aisles 230, the section labels 208 increment from left to right when facing the same side of the aisles 230. Section labels 208 for end caps 250 and wings 252 begin with “50” for each run 226 and increment moving from the front to the back of the store 209. FIG. 7A is another enlarged floor-plan view of certain fixtures 110 of the store 209 shown in FIG. 3, which full ASC number 114 assigned to the fixtures 110 shown.

As mentioned above, other types of fixtures 208 in the store 209 that do not include inventory to be mapped may still be assigned ASC numbers 114 to help in the verification process discussed below. The section labels 208 for these types of fixtures 110 can simply increment according to location of the fixtures 110. For example, the checkouts 214 can be assigned an ASC number 114 of “88801,” produce 216 can be assigned an incremented ASC number 114 of “88802,” and so on for other special-case sections of the store 209. These special sections of the store 209 can include but are not limited to checkouts 214, produce 216, bakery 218, deli, salad bar, meat/seafood counter 220, floral, pharmacy, bank, photo center 212, restaurant, snack bar, milk/dairy cooler 222, customer service, greeting cards/gift wrap/bags/ribbons, cosmetics, books/magazines, seasonal, and others. The assignment of ASC numbers 114 to the fixtures 110 of the store 209 according to the ASC numbering process described above is shown in FIG. 7B.

III. Exemplary Process

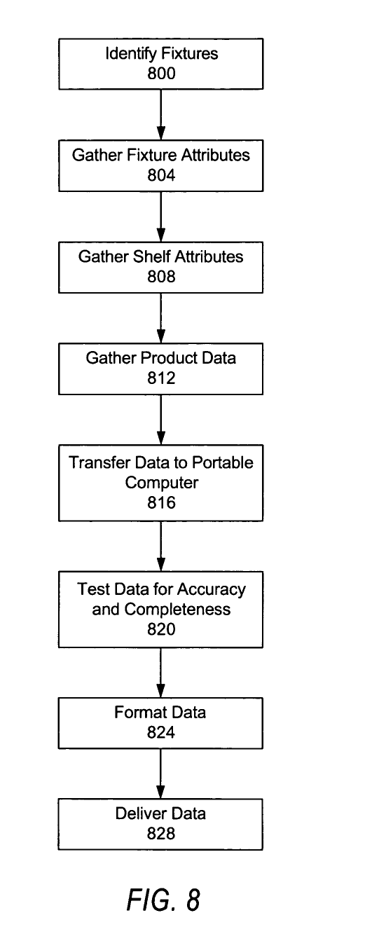

FIG. 8 is a flowchart diagram of an exemplary process flow for using inventory mapping to perform an inventory audit of the retail grocery store 209 of FIG. 3. The steps of the exemplary process flow shown in FIG. 8 may be varied without departing from the spirit or scope of the invention. For example, certain steps may be omitted or added to those shown in the Figure.

At step 800, fixtures 110 are identified. Step 800 can include determining ASC numbers 114 for the fixtures 110 based on the locations of the fixtures 110 in the store 209 and in relation to each other. Auditors 126 can use any of the rules discussed above to assign ASC numbers 114 to fixtures 110. The ASC numbers 114 can be written or printed onto fixture tags 112. The auditor 126 is able to attach the fixture tags 112 with ASC numbers 114 to the fixtures 110. Preferably, a fixture tag 112 is placed conspicuously on each fixture 110 having product data 132 to be gathered. For types of fixtures 110 that do not have product data 132 to be mapped, auditors 126 may place an “X” on fixture tags 112 attached to these fixtures 112. The “X” can be defined to indicate that the particular types of fixtures 110 do not have any inventory for mapping. Auditors 126 can place the fixture tags 112 at uniform positions on each fixture 110 to make them convenient to locate, such as at the upper left side of each fixture 110.

In one embodiment, fixtures 110 in the retail grocery store are assigned the ASC numbers 112 as shown in FIG. 7B. With the fixtures 110 in the store 209 identified by ASC numbers 114, the system 100 is able to use the assigned ASC numbers 114 and the rules for assigning the ASC numbers 114 to determine locations of, as well as positional relationships between, fixtures 110.

At step 804, fixture attributes 112 are gathered. Auditors 126 can use section-mapping forms 121 to record fixture attributes 112. Auditors 126 may systematically traverse areas of the store 209 to record fixture attributes 112. For a particular fixture 110, auditors 126 can record any of the following fixture attributes 112: ASC number 114; fixture type; fixture width; and fixture height. ASC numbers 114 for the left, right, and opposite adjacent fixtures 110 should also be recorded where applicable. The ASC numbers 114 for fixtures 110 can be collected from the fixture tags 112 that were attached to the fixtures 110 in step 800. Other fixture attributes 112 can be determined by observation and/or measurement of the fixtures 110, including any adjacent fixtures 110.

At step 808, shelf attributes 120 are gathered. Auditors 126 can use shelf-mapping forms 122 to record shelf attributes 120. For a particular shelf of a fixture 110, auditors may record the ASC number 114 for the fixture 110, a shelf number, a shelf width, a shelf height, and a shelf length. The ASC number 114 can be read from the fixture tag 112. Other fixture attributes 120 can be determined by observation and/or measurement of the shelves.

At step 812, product data 132 is gathered. Auditors 126 can input ASC numbers 114, shelf attributes 120, and product data 132 into the audit device 130. This can be done by manual data entry and/or by scanning product data 132. For example, the auditor 126 may key in the ASC number 114 for a particular fixture 110. A shelf number can also be keyed into the audit device 130. Shelf tags associated with the shelf can be scanned or keyed into the audit device 140. If there is not a shelf tag, a “0” should be input to indicate lack of a shelf tag. Auditors 126 can then use the audit device 130 to scan bar codes (UPCs) of products on the shelf. Auditors 126 may begin at the left-most product on the shelf and move to the right scanning each “facing” product. If a product is out or stock, auditors should enter a predetermined code (e.g., “888”) that the system 100 is configured to interpret to indicate an out-of-stock condition. If too few products are present on a shelf to completely fill the space available for “facing” products, auditors 126 can scan one of the present products multiple times according to how many “facing” products the auditors 126 may estimate as being able to fit in the space provided. By recording product data 132, the system 100 is able to determine the extent of space available on a shelf for displaying a front row of “facing” products. In other words, the system 100 can determine the number of products associated with a shelf that can be positioned at a forefront position on the shelf.

At step 816, the gathered data is transferred to the computer 136. This can be done by manual data entry and/or uploads from the audit device 130. The auditor 126 can manually input data from the forms 121, 122 and the audit device 130 into the computer 136. As discussed above, the computer 136 includes programming logic configured to provide menus, interfaces (e.g., GUIs), and processes that can be utilized by the auditor 126 to input data. Preferably, shelf attributes 120 are entered after section attributes 116 have been entered.

To enable the inputting of section attributes 116, the computer 136 provides an interface having data entry modules and fields into which auditor 126 can enter appropriate data for a particular fixture 110. In one embodiment, these fields include GUIs having fields for receiving an ASC number 114, fixture type, fixture width, fixture height, left ASC number 114, right ASC number 114, and opposite ASC number 114. Any of these fields can be configured to offer drop-down menus listing available choices. For example, a drop-down menu may be provided listing the possible types of fixtures 110 that can be selected.

The computer 136 can be configured to auto-populate certain interface fields to assist with data entry. For example, fixture attributes 112 (e.g., left ASC number) can be automatically populated when the left ASC number is known based on positional relationships of the fixtures 110 defined by ASC numbering process rules, which will be discussed below. The computer 136 can further be configured to allow auditors 126 to override fields that have been auto-populated.

To enable the inputting of shelf attributes 120, the computer 136 is configured to provide another interface having fields into which auditor 126 can enter appropriate data for a particular shelf. In one embodiment, these fields include fields for receiving an ASC number 114 for the fixture 110 of the particular shelf, shelf number, shelf height, and shelf depth. For reference, the interface may also indicate fixture attributes 112 related to the fixture 110 housing the particular shelf.

At step 820, the system 100 tests the transferred data for accuracy and completeness. The programming logic of the computer 136 can be configured to analyze the inputted mapping data 138, checking it for errors based on positional relationships of fixtures 110 as defined by the fixture mapping rules and ASC numbers 114 of the mapped fixtures 110. In step 820, the computer 136 can perform any of the verification functions described above to identify possible errors or omissions in the product data 132. For example, the particular fixture 110 section identified by the ASC number 114 of “02102” should have fixture attributes 112 identifying fixtures 110 (by ASC numbers 114) to the left, right, and opposite of the “02102” fixture 110 section. Thus, the fixture attributes 112 for the “02102” fixture 110 should include a left ASC number 114 of “02101,” a right ASC number of “02103,” and an opposite ASC number 114 of “02202” to correctly identify the fixtures 110 to the left, right, and opposite of the “02102” fixture 110 section according to the exemplary ASC numbering process described above. At step 820, the system 100 may verify that these fixture attributes 112 correspond with the implemented ASC numbering process rules. If they do not correspond with the rules, an error message can be made available to notify auditors 126. Such a check can be performed for each fixture 110 that has been assigned an ASC number 114. In this manner, the system 100 can use positional relationships defined by the ASC numbers 114 to identify errors and omissions in the product data 132.

At step 822, the computer 136 generates output indicative of the positional relationships of the fixtures 110 to each other. The output may also be indicative of the positions of products and/or shelves in relation to each other or in relation to the fixtures 110. This output can be in various forms, including but not limited to data streams, tables, spreadsheets, text, graphical representations, hardcopies, reports, etc. The output can be generated for customers and may include tables of fixtures 110 and their associated product categories and other mapping data 138.

The generation of output at step 822 can include inserting the received fixture attributes 112, ASC numbers 114, shelf attributes 120, and product data 132 into databases and accessing the data in the database to generate mapping and/or inventory reports (e.g., section reports, shelf reports, area detail reports, and missing data reports). Categories of products can be identified in the databases and associated with appropriate fixtures 110. For example, if a particular shelf of a particular fixture 110 holds hair-care products, the record in the database for that same shelf and fixture 110 can be associated with hair-care categories.

At step 824 of FIG. 8, the computer 136 formats the output. The output may be formatted to generate the inventory mapping data 138. The output can be formatted into any of the forms listed above (e.g., reports) or other formats in preparation for sending the inventory mapping data 138 to another entity (e.g., a customer) for further processing. At step 828, the product data 132 can be delivered to another entity, such as a regional or central location, for further processing, in any of the ways mentioned above.

In conclusion, the system and method described above provide for mapping inventory using a novel process for numbering fixtures 110 based on location and positional relationships with other fixtures 110. The positional relationships are utilized to generate output indicative of the positions of products in relation to the fixtures 110 and/or in relation to other products. The output can be sent to customers to aid in the analysis of actual inventory layouts of stores, especially when compared to planned optimal inventory layouts. Thus, the system and method described above are configured to provide customers with up-to-date and accurate representations of actual stocking and layout of inventories.

The preceding description has been presented only to illustrate and describe embodiments of the invention. It is not intended to be exhaustive or to limit the invention to any precise form disclosed. Many modifications and variations are possible in light of the above teaching. It is intended that the scope of the invention be defined by the following claims.

What is claimed is:

1. An inventory mapping method, comprising:
assigning fixture codes to inventory fixtures, said fixture codes being indicative of positional relationships of said inventory fixtures to each other;
gathering fixture attributes associated with said inventory fixtures, said fixture attributes including said fixture codes; and
generating output from said fixture attributes, said output being indicative of said positional relationships of said inventory fixtures to each other.

2. The method of claim 1, further comprising:
gathering product data of products associated with said inventory fixtures; and
generating output data indicative of positions of said products in relation to said inventory fixtures.

3. The method of claim 2, wherein said product data includes product categories, and said output data is indicative of positions of said product categories in relation to said inventory fixtures.

4. The method of claim 3, wherein said output data is indicative of said positions of said product categories in relation to each other.

5. The method of claim 4, further comprising delivering said output and said output data to a customer.

6. The method of claim 4, further comprising:
formatting said output and said output data; and
delivering said formatted output and output data to a customer.

7. The method of claim 6, wherein said formatted output and output data includes a graphical representation of said inventory fixtures.

8. The method of claim 6, wherein said formatted output and output data is in report form.

9. The method of claim 2, wherein said step of gathering said product data includes scanning said product data from at least one of said products and said inventory fixtures.

10. The method of claim 1, wherein said fixture codes comprise aisle-section-category (ASC) numbers.

11. The method of claim 10, wherein said ASC numbers each include an aisle label, a side label, and a section label.

12. The method of claim 11, wherein said aisle label identifies an aisle, said side label identifies a side of the aisle, and said section label identifies a fixture section on the side of the aisle.

13. The method of claim 10, wherein said inventory fixtures include a first inventory fixtures and an adjacent inventory fixture, and said ASC numbers include a first ASC number and a second ASC number, wherein said first inventory fixture is assigned said first ASC number and further includes said second ASC number identifying said adjacent inventory fixture.

14. The method of claim 13, wherein said inventory fixtures further include a second adjacent inventory fixture and a third adjacent inventory fixture, and wherein said first inventory fixture further includes a third ASC number identifying said second adjacent inventory fixture and a fourth ASC number identifying said third adjacent inventory fixture.

15. The method of claim 1, further comprising:
gathering shelf attributes associated with shelves of said inventory fixtures, said shelf attributes being indicative of positions of said shelves; and
generating shelf output from said shelf attributes, said shelf output being indicative of said positions of said shelves in relation to said inventory fixtures.

16. An inventory mapping method, comprising:
assigning ASC numbers to a plurality of inventory fixtures, said plurality of inventory fixtures including a first fixture and an adjacent fixture, wherein each of said plurality of inventory fixtures is assigned a unique ASC number, and wherein said ASC numbers are assigned based on aisle locations, aisle-side locations, and section locations of said plurality of inventory fixtures in an inventory target area;
gathering fixture attributes associated with said plurality of inventory fixtures, said fixture attributes indicating said ASC numbers;
gathering product data of products associated with said plurality of inventory fixtures;
entering said ASC numbers, said fixture attributes, and said product data into a database; and
generating output indicative of positional relationships of said products and said plurality of inventory fixtures to each other, wherein said positional relationships are defined by said ASC numbers.

17. The method of claim 16, wherein said product data is indicative of product categories, and said output is indicative of positions of said product categories in relation to each other.

18. The method of claim 16, wherein said product data is indicative of product categories, and said output is indicative of positions of said product categories in relation to said inventory fixtures.

19. The method of claim 16, further comprising delivering said output to a customer.

20. The method of claim 16, further comprising:
formatting said output; and
delivering said formatted output to a customer.

21. The method of claim 20, wherein said formatted output includes a graphical representation of said inventory fixtures.

22. The method of claim 20, wherein said formatted output is in report form.

23. The method of claim 16, wherein said step of gathering said product data includes scanning said product data from at least one of said products and said inventory fixtures.

24. The method of claim 16, wherein said ASC numbers each include an aisle label, a side label, and a section label.

25. The method of claim 16, wherein said ASC numbers include a first ASC number and a second ASC number, and wherein said first inventory fixture is assigned said first ASC number and further includes said second ASC number identifying said adjacent inventory fixture.

26. The method of claim 25, wherein said ASC numbers further include a third ASC number and a fourth ASC number, said plurality of inventory fixtures further including a second adjacent inventory fixture and a third adjacent inventory fixture, and wherein said first inventory fixture includes said third ASC number identifying said second adjacent inventory fixture and said fourth ASC number identifying said third adjacent inventory fixture.

27. The method of claim 16, further comprising:
gathering shelf attributes associated with shelves of said inventory fixtures, said shelf attributes being indicative of positions of said shelves in relation to said inventory fixtures; and
generating shelf output from said shelf attributes, said shelf output being indicative of said positions of said shelves in relation to said inventory fixtures.

28. An inventory mapping system, comprising:
fixture codes assigned to a plurality of inventory fixtures based on positional relationships between said plurality of inventory fixtures;
fixture attributes associated with said plurality of inventory fixtures, said fixture attributes indicating said positional relationships; and
a computer having software configured to direct said computer to perform the steps of:
receiving data representative of said fixture attributes; and
generating output indicative of said positional relationships of said inventory fixtures to each other.

29. The system of claim 28, further comprising:
product data of products associated with said inventory fixtures, wherein said software is further configured to direct said computer to perform a step of receiving data representative of said product data, and wherein said output is indicative of positions of said products in relation to said inventory fixtures.

30. The system of claim 29, wherein said product data includes product categories, and said output data is indicative of positions of said product categories in relation to said inventory fixtures.

31. The system of claim 30, wherein said output data is indicative of said positions of said product categories in relation to each other.

32. The system of claim 28, wherein said software is further configured to direct said computer to perform a step of delivering said output to a customer.

33. The system of claim 28, wherein said software is further configured to direct said computer to perform the steps of:
formatting said output; and
delivering said formatted output to a customer.

34. The system of claim 33, wherein said formatted output includes a graphical representation of said inventory fixtures.

35. The system of claim 33, wherein said formatted output is in report form.

36. The system of claim 28, wherein said fixture codes comprise aisle-section-category (ASC) numbers.

37. The system of claim 36, wherein said ASC numbers each include an aisle label, a side label, and a section label.

38. The system of claim 37, wherein said aisle label identifies an aisle, said side label identifies a side of the aisle, and said section label identifies a fixture section on the side of the aisle.

39. The system of claim 28, further comprising fixture tags identifying said plurality of inventory fixtures, said fixture tags including said fixture codes for display.

40. The system of claim 28, further comprising forms configured for recordation of said fixture attributes.

41. The system of claim 28, wherein said software is further configured to direct said computer to perform a step of providing data-entry interfaces, wherein said interfaces include fields for receiving said data.

42. The system of claim 41, wherein said data-entry interfaces provide available options for said fixture attributes.

43. The system of claim 41, wherein said software is further configured to direct said computer to perform a step of auto-populating said fields based on said positional relationships.

44. The system of claim 28, further comprising an audit device configured for gathering product data of products associated with said inventory fixtures, said audit device including a scanner for scanning product information.

45. The system of claim 44, wherein said software is further configured to direct said computer to perform a step of receiving said product data.
